(19) United States
(12) Patent Application Publication
(10) Pub. No.: US 2013/0099944 A1
(43) Pub. Date: Apr. 25, 2013

(54) FLUID PRESSURE BASED ICING DETECTION FOR A TURBINE ENGINE

(71) Applicants: David Richard Hanson, Tempe, AZ (US); Dave Dischinger, Tempe, AZ (US); Ronald Goodwin, Mesa, AZ (US); John Repp, Gilbert, AZ (US)

(72) Inventors: David Richard Hanson, Tempe, AZ (US); Dave Dischinger, Tempe, AZ (US); Ronald Goodwin, Mesa, AZ (US); John Repp, Gilbert, AZ (US)

(73) Assignee: HONEYWELL INTERNATIONAL INC., Morristown, NJ (US)

(21) Appl. No.: 13/277,002

(22) Filed: Oct. 19, 2011

(51) Int. Cl. G08B 21/00; F02G 3/00

(52) U.S. Cl. 340/962; 60/39.093

(57) ABSTRACT

An icing detection subsystem for an aircraft turbine engine is presented. The icing detection subsystem includes a plurality of air pressure sampling ports formed within structure that surrounds a rotating component of the aircraft turbine engine. The subsystem also includes a pressure sensor arrangement coupled to the plurality of air pressure sampling ports to obtain air pressure measurements for the plurality of air pressure sampling ports. A processing module is coupled to the pressure sensor arrangement to analyze the air pressure measurements over time during operation of the aircraft turbine engine, and to generate an alert when at least one characteristic of the air pressure measurements over time is indicative of the presence of ice in the aircraft turbine engine.

### TECHNICAL FIELD

Embodiments of the subject matter described herein relate generally to icing detection for a turbine engine, such as an aircraft turbine engine. More particularly, embodiments of the subject matter relate to an icing detection methodology that is based on the monitoring of air pressure at certain locations in the turbine engine.

### BACKGROUND

A number of different aircraft use turbine engines to generate thrust, generate torque for driving propellers and rotors, generate electricity, generate compressed air, generate hydraulic pressure, etc. The design, configuration, and operation of such turbine engines are well known. A turbine engine includes rotating components that rotate at a high speed during operation. For example, a typical turbine engine includes low pressure and/or high pressure compressors, and may include a fan, which include respective rotors to accommodate rotating elements. During flight under ice-forming conditions, ice accreting in the fan and/or compressor of a turbine engine can reduce thrust and engine stability and otherwise degrade performance of the engine. Accordingly, early icing detection is desirable to allow the flight crew and/or onboard systems to take appropriate anti-icing or de-icing measures before engine performance is adversely affected.

Some icing detection systems monitor engine performance in an attempt to detect when ice has formed in the engine. Although such techniques are useful, they typically rely on the detection of ice after the ice has already formed. Moreover, certain changes in engine performance need not always be indicative of the presence of ice. Consequently, such traditional methodologies may result in false detection under certain operating conditions.

Accordingly, it is desirable to have an improved icing detection subsystem suitable for use with an aircraft turbine engine. In addition, it is desirable to have an improved icing detection technique that need not rely on the monitoring of engine performance to detect the presence of ice. Furthermore, other desirable features and characteristics will become apparent from the subsequent detailed description and the appended claims, taken in conjunction with the accompanying drawings and the foregoing technical field and background.

### BRIEF SUMMARY

An exemplary embodiment of a method for detecting icing in an aircraft turbine engine is provided here. The method measures air pressure at a port located near a rotating component of the aircraft turbine engine to obtain air pressure measurements, and warns of a potential icing condition when at least one characteristic of the air pressure measurements over time is indicative of the presence of ice covering the port.

An exemplary embodiment of a turbine engine is also provided. The turbine engine includes a rotating component and structure associated with the rotating component, wherein the rotating component rotates within the structure when the turbine engine is operating. The turbine engine also includes an air pressure sampling port formed within the structure and exposed to airspace defined within the structure, a pressure sensor fluidly coupled to the air pressure sampling port to obtain air pressure measurements for the air pressure sampling port, and a processing module coupled to the pressure sensor to analyze the air pressure measurements over time and to determine when at least one characteristic of the air pressure measurements over time is indicative of the presence of ice at the air pressure sampling port.

Also provided is an exemplary embodiment of an icing detection subsystem for an aircraft turbine engine. The icing detection subsystem includes a plurality of air pressure sampling ports formed within structure that surrounds a rotating component of the aircraft turbine engine, and a pressure sensor arrangement coupled to the plurality of air pressure sampling ports to obtain air pressure measurements for the plurality of air pressure sampling ports. The subsystem also includes a processing module coupled to the pressure sensor arrangement to analyze the air pressure measurements over time during operation of the aircraft turbine engine, and to generate an alert when at least one characteristic of the air pressure measurements over time is indicative of the presence of ice in the aircraft turbine engine.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a partially cutaway/phantom view of an exemplary embodiment of a turbine engine;

FIG. 2 is a schematic representation of an exemplary embodiment of an icing detection subsystem for a turbine engine;

FIG. 3 is an exemplary plot of pressure versus time corresponding to a normal operating condition of a turbine engine; and

FIG. 4 is an exemplary plot of pressure versus time corresponding to an icing condition of a turbine engine.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

In addition, certain terminology may also be used in the following description for the purpose of reference only, and thus are not intended to be limiting. For example, terms such as “upper”, “lower”, “above”, and “below” may refer to directions in the drawings to which reference is made. Terms such as “fore”, “aft”, “side”, “outboard”, and “inboard” may be used to describe the orientation and/or location of portions of a component or feature within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

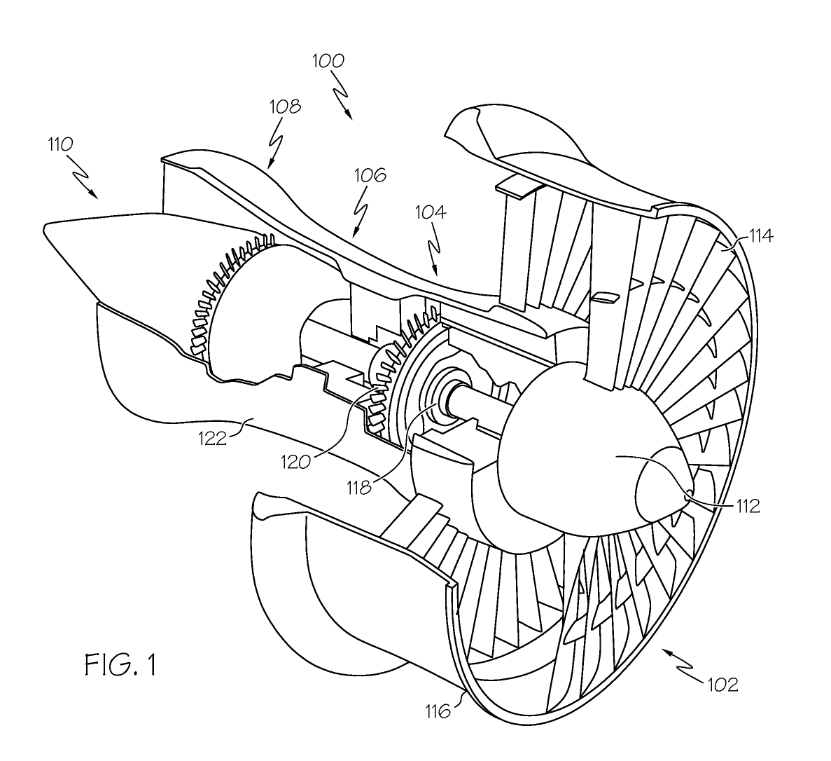

FIG. 1 is a partially cutaway/phantom view of an exemplary embodiment of a turbine engine 100, which is typical of the turbofan type used to provide thrust for aircraft. It should be appreciated that the techniques, technology, and methodologies described herein are applicable to any number of engine configurations including (without limitation): turbofan engines; turboprop engines; turboshaft engines, auxiliary power units; or the like. Although the exemplary embodiment described here relates to a turbofan engine, the subject matter and concepts presented here can be extended as needed to accommodate different engine configurations if so desired.

The fundamental configuration and operation of the turbine engine 100 are well known and, therefore, such details will not be described in detail here. In accordance with conventional architectures, the turbine engine 100 includes an air inlet section 102, a compressor section 104, a combustion section 106, a turbine section 108, and an exhaust section 110. In a traditional aircraft deployment, the turbine engine 100 is oriented for a flowpath in the fore-aft direction. In this regard, the air inlet section 102 corresponds to the fore direction of the aircraft, and the exhaust section 110 corresponds to the aft direction of the aircraft.

The air inlet section 102 includes a fan rotor 112 for fan 114 that rotates within an associated structure such as a fan housing 116, which serves as a flowpath shroud in this example. The fan 114 is one example of a rotating component of the turbine engine 100, which rotates within the fan housing 116 during operation of the turbine engine 100. In a typical implementation, the fan housing 116 surrounds or encloses the outer perimeter defined by the ends of the fan blades.

The compressor section 104 includes at least one other rotating component of the turbine engine 100, namely, a compressor rotor 118 having compressor blades 120 coupled thereto. When the turbine engine 100 is operating, the compressor rotor 118 and compressor blades 120 rotate within an associated structure such as an engine core housing 122, which serves as a flowpath shroud in this example. In a typical configuration, the engine core housing 122 surrounds or encloses the outer perimeter defined by the tips of the compressor blades 120.

Although not visible in FIG. 1, the turbine engine 100 includes one or more air pressure sampling ports formed within certain structural elements. As described in more detail below, the air pressure sampling ports form part of a suitably configured icing detection subsystem for the aircraft turbine engine 100. An air pressure sampling port may be realized as a small hole, outlet, or conduit formed in the structural element such that the air pressure sampling port is exposed to the airspace defined within the structural element. For example, air pressure sampling ports may be formed within the fan housing 116 (at various fore-aft locations) and/or within the engine core housing 122 (at various fore-aft locations) for purposes of measuring the pressure within the fan housing 116 and/or the engine core housing 122. In certain embodiments, each air pressure sampling port is created as a hole that is drilled, machined, or otherwise formed in the material that forms the fan housing 116 and/or the engine core housing 122. In an exemplary embodiment, each air pressure sampling port has a diameter suitable for pressure measurement without being obtrusive to the airflow. In accordance with one non-limiting embodiment, each air pressure sampling port may have a diameter on the order of about 0.10 inch.

The air pressure sampling ports are strategically positioned at locations that might be prone to the accretion of ice during operation of the turbine engine in typical icing conditions. In this regard, the air pressure sampling ports may be distributed circumferentially around the engine structure and/or distributed along the engine structure in the fore-aft dimension as needed to provide the necessary “coverage” in anticipation of the formation of ice. As explained below, the air pressure sampling ports may be located at positions aft of the rotating components for better detection of air pressure variations caused by the rotating components. Although only one air pressure sampling port could be used, preferred embodiments employ a plurality of air pressure sampling ports. Depending upon the particular deployment and engine configuration, the turbine engine 100 may include up to twenty (or more) distinct air pressure sampling ports.

As mentioned above, an icing detection subsystem of the type described here could be deployed in a turbofan engine, a turboprop engine, a turboshaft engine, or other suitable applications. The number, location, size, and/or other characteristics of the air pressure sampling ports may be dictated by the particular deployment, engine type, and the number and type of rotating elements in the particular engine. In other words, the configuration, layout, and positioning of the air pressure sampling ports may need to be customized or otherwise determined to best suit the needs of the particular engine deployment.

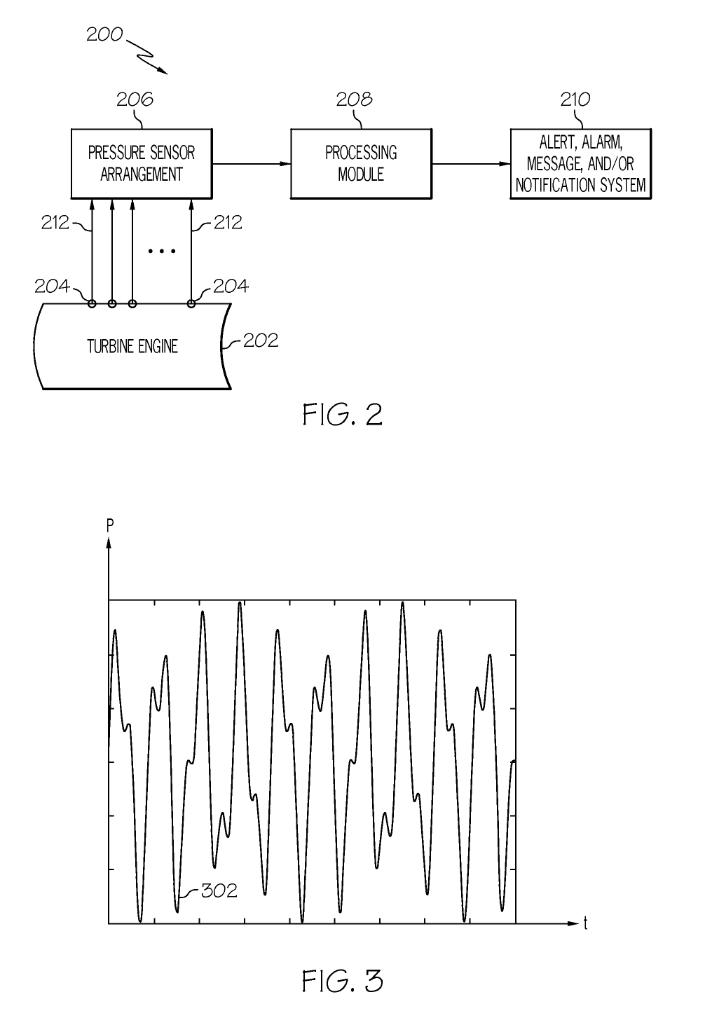

FIG. 2 is a schematic representation of an exemplary embodiment of an icing detection subsystem 200 for a turbine engine 202 (which may, but need not, be configured as shown in FIG. 1). The icing detection subsystem 200 may include, without limitation: a plurality of air pressure sampling ports 204; a pressure sensor arrangement 206 coupled to the air pressure sampling ports 204; a processing module 208; and an alert, alarm, message, and/or notification system 210. As described above, the air pressure sampling ports 204 may be formed within certain structure of the turbine engine 202. The icing detection subsystem 200 may include conduits 212 fluidly coupled between the air pressure sampling ports 204 and the pressure sensor arrangement 206 to enable the pressure sensor arrangement 206 to monitor and measure air pressure at the different air pressure sampling ports 204. The conduits 212 may be realized as drilled or otherwise fabricated passageways within the structure of the turbine engine 202, as tubes formed from metal, plastic, or any suitable material, as flexible hoses, or the like.

The pressure sensor arrangement 206 may include one or more air pressure sensors, transducers, or measurement devices. In certain embodiments, the pressure sensor arrangement 206 includes a different, distinct, separate, and independent air pressure sensor for each air pressure sampling port 204. In other embodiments, the pressure sensor arrangement 206 includes at least one shared pressure sensor that obtains air pressure measurements for at least two different air pressure sampling ports 204. In yet other embodiments, the pressure sensor arrangement 206 includes one or more pressure sensors assigned to the air pressure sampling ports 204 on a one-to-one basis, and one or more shared pressure sensors that monitor other air pressure sampling ports 204. In operation, a shared pressure sensor can be controlled to selectively sample a plurality of air pressure sampling ports 204 using, for example, a controllable valve or flowpath device having multiple inlets and one outlet. The shared pressure sensor can then be provided with the monitored pressure associated with any one of a plurality of different air pressure sampling ports 204.

The processing module 208 may include or be implemented with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor device may be realized as a microprocessor, a controller, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. In a typical deployment, the processing module 208 can be implemented within any computing device, system, or hardware located onboard the host aircraft.

The processing module 208 is coupled to the pressure sensor arrangement 206 to analyze the air pressure measurements over time, and to determine when at least one detectable or computable characteristic of the air pressure measurements is indicative of the presence of ice at or near one or more of the air pressure sampling ports 204. In this regard, the pressure sensor arrangement 206 and/or the processing module 208 can be suitably configured to process, convert, or otherwise format the air pressure sensor data as needed for purposes of analysis and interpretation. For example, the processing module 208 may be configured to analyze an amount of variation in magnitude of the fluid pressure measurements over time, and to indicate a potential icing condition when the amount of variation in magnitude is less than a threshold magnitude value. As another example, the processing module 208 may analyze frequency content of the fluid pressure measurements over time, and indicate a potential icing condition when the frequency content is less than a threshold frequency value.

FIG. 3 is an exemplary plot 302 of pressure versus time corresponding to a normal operating condition of a turbine engine. The plot 302 represents a typical pressure characteristic for one air pressure sampling port when no ice is present at or near the port. The plot 302 exhibits a distinctive and detectable fluctuation in pressure magnitude, which corresponds to a pulsation or wake effect caused by movement of the rotating components near the corresponding air pressure sampling port. In practice, the variation in pressure magnitude is more pronounced (and, therefore, easier to detect) at a location that is aft of and near to the rotating component. For this reason, the air pressure sampling ports 204 should be located close to and behind the rotating blades of the fan 114 and/or close to and behind the rotating compressor blades 120. During operating conditions where ice is not accreting in the turbine engine 202, the air pressure sampling ports 204 will remain unobstructed by ice. Consequently, the measured air pressure magnitude for each air pressure sampling port 204 will have the general variation exhibited by the plot 302.

Moreover, the measured air pressure under ice-free conditions will exhibit certain cyclical characteristics having detectable or computable frequency content. As shown in FIG. 3, the plot has a primary frequency component that is associated with the predominant peaks and valleys. This frequency component corresponds to the movement of the rotating blades of the fan 114 and/or the rotating compressor blades 120 past the air pressure sampling port 204. Accordingly, the dominant frequency component will be dictated by the rotational speed of the rotating component of the turbine engine and by the number of blades in compressor rotors adjacent to the air pressure sampling port.

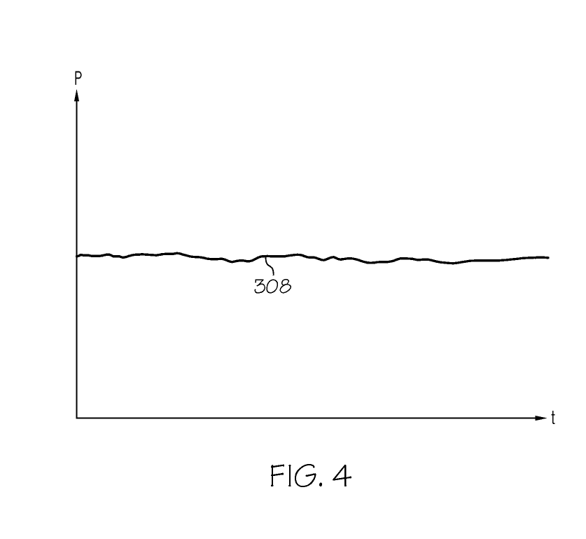

If ice forms within the turbine engine 202, it may form in a way that partially or fully covers, blocks, or clogs the air pressure sampling ports 204. When ice forms over an air pressure sampling port 204, the pressure sensor arrangement 206 and the processing module 208 detect a change in the pressure characteristics. In this regard, FIG. 4 is an exemplary plot 308 of pressure versus time corresponding to an icing condition of the turbine engine 202. As depicted in FIG. 4, under icing conditions the air pressure measurement exhibits attenuated variation in magnitude when ice covers the air pressure sampling port 204. In addition, the plot 308 includes less frequency content relative to the plot 302 shown in FIG. 3. These and possibly other detectable or computable characteristics of the air pressure measurements over time are indicative of the presence of ice in the turbine engine 202. More specifically, these detectable aspects of pressure versus time are caused by the ice blockage of the air pressure sampling ports 204 and, consequently, the inability of the pressure sensor arrangement 206 to continue measuring the actual pressure within the turbine engine 202. Instead, the “measured” pressure will become constant or virtually constant, representing the pressure within the conduits 212 at the time of ice formation.

In response to the detection of a potential icing condition, the processing module 208 generates or initiates an alert, an alarm, a warning indicator, and/or a message. The system 210 cooperates with the processing module 208 in this respect to annunciate an appropriate alert or alarm for the flight crew, to activate a warning light or other indicator, or to take appropriate action as needed. This alerting feature enables the flight crew or a control system of the aircraft to respond in a way that is intended to address the potential icing condition. For example, the pilot may decide to alter the altitude of the aircraft, to navigate the aircraft differently, to change power setting, or the like.

The expected variation of pressure with time varies with fan and compressor design, rotational speed, air pressure sampling port location, and engine inlet pressure as measured by inlet pressure sensors that may already be part of a turbine engine control system. The criteria, conditions, or measurement thresholds that are used to determine whether or not an ice is present in the turbine engine 202 can be selected based on test data, empirical measurements, historical data, analytical predictions, or the like. For example, the subsystem 200 could indicate the presence of ice if any one of the air pressure sampling ports 204 appears to be occluded. Alternatively, the subsystem 200 may be configured to only indicate the presence of ice when a predetermined number (e.g., three or more) of the air pressure sampling ports 204 appear to be occluded.

While at least one exemplary embodiment has been presented in the foregoing detailed description, it should be appreciated that a vast number of variations exist. For example, the techniques and methodology described here could be implemented in other applications that involve rotating elements or components, or in applications that might be subjected to the accretion of ice in or on non-rotating components. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for detecting icing in an aircraft turbine engine, the method comprising:
measuring air pressure at a port located near a rotating component of the aircraft turbine engine to obtain air pressure measurements; and
warning of a potential icing condition when at least one characteristic of the air pressure measurements over time is indicative of the presence of ice covering the port.

2. The method of claim 1, wherein the port is located aft of the rotating component.

3. The method of claim 1, wherein the rotating component is a fan of the aircraft turbine engine.

4. The method of claim 1, wherein the rotating component is a compressor rotor of the aircraft turbine engine.

5. The method of claim 1, wherein the warning step indicates the potential icing condition when an amount of variation in magnitude of the air pressure measurements is less than a threshold magnitude value.

6. The method of claim 1, wherein the warning step indicates the potential icing condition when frequency of the air pressure measurements over time is less than a threshold frequency value.

7. The method of claim 1, further comprising:
generating a flight crew alert in response to the warning.

8. The method of claim 1, wherein:
the aircraft turbine engine comprises a plurality of air pressure sampling ports, including the port located near the rotating component;
the method further comprises measuring air pressure at the plurality of air pressure sampling ports to obtain respective air pressure measurements for each of the plurality of air pressure sampling ports; and
warning of the potential icing condition when at least one characteristic of any of the respective air pressure measurements over time is indicative of the presence of ice.

9. A turbine engine comprising:
a rotating component;
structure associated with the rotating component, wherein the rotating component rotates within the structure when the turbine engine is operating;
an air pressure sampling port formed within the structure and exposed to airspace defined within the structure;
a pressure sensor fluidly coupled to the air pressure sampling port to obtain air pressure measurements for the air pressure sampling port; and
a processing module coupled to the pressure sensor to analyze the air pressure measurements over time and to determine when at least one characteristic of the air pressure measurements over time is indicative of the presence of ice at the air pressure sampling port.

10. The turbine engine of claim 9, wherein the air pressure sampling port is positioned at a location aft of the rotating component.

11. The turbine engine of claim 9, wherein the rotating component is a fan of the turbine engine.

12. The turbine engine of claim 9, wherein the rotating component is a compressor rotor of the turbine engine.

13. The turbine engine of claim 9, wherein the processing module analyzes an amount of variation in magnitude of the fluid pressure measurements over time, and indicates a potential icing condition when the amount of variation in magnitude is less than a threshold magnitude value.

14. The turbine engine of claim 9, wherein the processing module analyzes frequency content of the fluid pressure measurements over time, and indicates a potential icing condition when the frequency content is less than a threshold frequency value.

15. The turbine engine of claim 9, wherein the structure comprises a flowpath shroud.

16. The turbine engine of claim 9, further comprising a conduit coupled between the air pressure sampling port and the pressure sensor.

17. An icing detection subsystem for an aircraft turbine engine, the icing detection subsystem comprising:
a plurality of air pressure sampling ports formed within structure that surrounds a rotating component of the aircraft turbine engine;
a pressure sensor arrangement coupled to the plurality of air pressure sampling ports to obtain air pressure measurements for the plurality of air pressure sampling ports; and
a processing module coupled to the pressure sensor arrangement to analyze the air pressure measurements over time during operation of the aircraft turbine engine, and to generate an alert when at least one characteristic of the air pressure measurements over time is indicative of the presence of ice in the aircraft turbine engine.

18. The icing detection subsystem of claim 17, wherein the pressure sensor arrangement comprises a plurality of different pressure sensors.

19. The icing detection subsystem of claim 17, wherein the pressure sensor arrangement comprises a shared pressure sensor that obtains air pressure measurements for at least two different ones of the plurality of air pressure sampling ports.

20. The icing detection subsystem of claim 17, wherein:
under normal operating conditions the air pressure measurements exhibit variation in magnitude at a frequency corresponding to movement of the rotating component near the plurality of air pressure sampling ports;
under icing conditions the air pressure measurements exhibit attenuated variation in magnitude when ice covers at least some of the plurality of air pressure sampling ports; and
the processing module generates an alert when the attenuated variation in magnitude is detected.
